(19) United States
(12) Patent Application Publication
(10) Pub. No.: US 2004/0065672 A1
(43) Pub. Date: Apr. 8, 2004

(54) Cup dispenser

(75) Inventor: Robert Kaplan, Lake Forest, CA (US)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(73) Assignee: California Quality Plastics, Inc.

(21) Appl. No.: 10/264,982

(22) Filed: Oct. 4, 2002

(51) Int. Cl. G07F 11/16

(52) U.S. Cl. 221/303

(57) ABSTRACT

A cup dispenser has an aperture having at least four arms, and a gasket functionally attached to the aperture and defining an opening such that movement of the arms changes the size of the opening.

### FIELD OF THE INVENTION

The field of the invention is dispensers for disposable drinking cups.

### BACKGROUND OF THE INVENTION

Many convenience stores, fast-food restaurants, and other establishments use disposable drinking cups. Such cups are typically dispensed through spring-loaded cup dispensers. The most commercially successful dispensers reliably dispense one cup at a time, with minimal effort being expended by the users, and little or no damage to the cups. Examples are set forth at U.S. Pat. No. 4,234,101 to Pastore (November 1980) and U.S. Pat. No. 5,709,316 to Jolly at al. (January 1998).

Although known cup dispensers meet the basic needs of the marketplace, they are difficult to adapt from one cup size to another. Typically the cups are separated from one another by a gasket, and adaptation to a different cup size requires replacement of the gasket.

What is needed is a disposable cup dispenser that more readily adapts to different cup sizes.

### SUMMARY OF THE INVENTION

Methods and apparatus are provided in which a dispenser for disposable cups (also referred to as a disposable cup dispenser) comprises an aperture having a plurality of arms and a gasket coupled to the arms. Adjustment of the arms modifies the opening of the gasket, which alters the gasket opening, and thereby adapts the device to different cup sizes.

In particularly preferred embodiments the aperture has four arms, and the gasket comprises a rubber or rubber-like material.

Various objects, features, aspects and advantages of the present invention will become more apparent from the following detailed description of preferred embodiments of the invention, along with the accompanying drawings.

### BRIEF DESCRIPTION OF THE DRAWINGS

FIG. 1 is a perspective view of an inventive cup dispenser.

FIG. 2 is an exploded view of the face plate, retainer arms, gasket and adjustment mechanism of the cup dispenser of FIG. 1.

### DETAILED DESCRIPTION

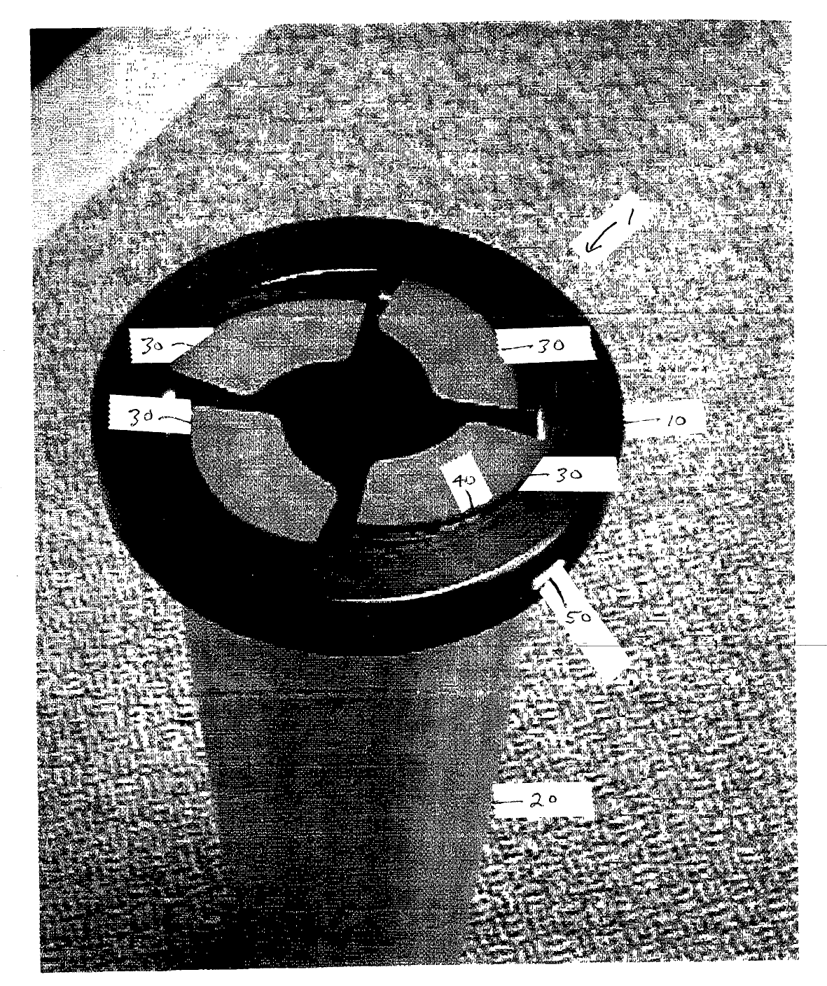

FIG. 1 generally depicts a cup dispenser 1 having a face plate 10, a tube 20, a cup pusher (not shown), and a plurality of retainer arms 30, a gasket 40, and an adjustment mechanism 50.

The tube 10 is constructed from metal, plastic, or other sufficiently rigid, durable, and non-toxic material. Internal diameters are relatively standard in the industry, typically 5″. Suitable tubes can have any length between about 18″ and about 24″.

The cup pusher (not shown) is a conventional spring-loaded apparatus, that biases a stack of cups towards the face plate 10.

FIG. 1 depicts four retainer arms 30 spaced evenly around the inner circumference of the aperture, and pivoting to effectively enlarge or reduce the size of the aperture that retains the cups. Other contemplated dispensers include those having three or five arms. The specific dimensions of the arms are not especially critical, although suitable arms are preferably curved at their inner borders to increase the contact area with the cups (not shown). Suitable arms can be made from metal, plastic, or other sufficiently rigid, durable, and non-toxic material, that need not be the same as that comprising the tube or face plate.

Gasket 40 is a thermal plastic rubber, but can alternatively be any suitably flexible material, including many polymers and rubber-like materials.

Adjustment mechanism 50 is a slide that moves the retainer arms. Those skilled in the art will appreciate that there are numerous alternative adjustment mechanisms, and all such alternatives are contemplated.

In contemplated cup dispensers such as that in FIG. 1, the tube is mounted horizontally (or off-horizontally) into a cabinet, with the face plate shoeing on the outside of the cabinet. A sleeve of cups is front-loaded into the cup dispenser, and pulled out one cup at a time by a consumer or employee.

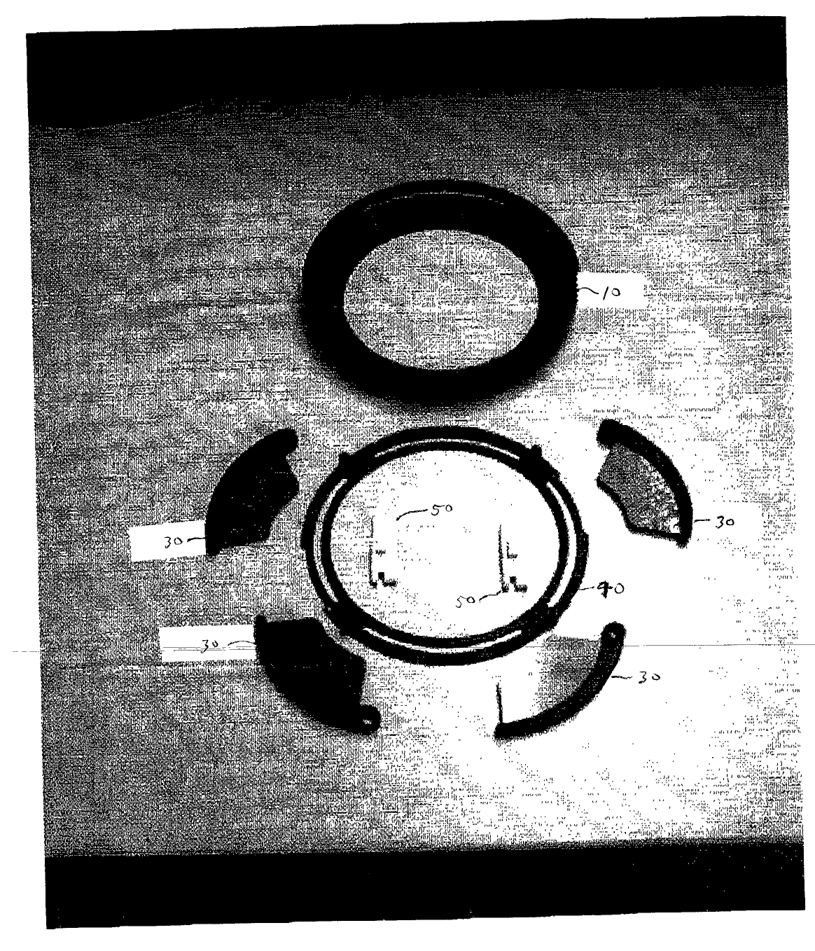

FIG. 2 is an exploded view of the face plate 10, retainer arms 30, a gasket 40, and adjustment mechanism 50 of the cup dispenser of FIG. 1.

Thus, specific embodiments and applications of cup dispensers have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A disposable cup dispenser comprises an aperture having a plurality of arms, and a gasket coupled to the aperture and defining an opening such that movement of the arms changes the size of the opening.

2. The dispenser of claim 1 wherein the plurality of arms comprises at least four arms.

3. The dispenser of claim 1 wherein the plurality of arms comprises four arms.

4. The dispenser of claim 1 wherein the gasket comprises a polymer.

5. The dispenser of claim 1 wherein the gasket comprises a rubber.

6. The dispenser of claim 1 wherein the plurality of arms comprises four arms, and the gasket comprises a rubber.

7. The dispenser of claim 1 further comprising a sliding adjustment mechanism that cooperates with the plurality of arms to change the size of the opening.
